(19) United States
(12) Patent Application Publication
(10) Pub. No.: US 2026/0227795 A1
(43) Pub. Date: Aug. 6, 2026

(54) MOVEMENT CONTROL SYSTEM, MOVEMENT CONTROL METHOD, AND MOVEMENT CONTROL PROGRAM

(71) Applicant: MITSUBISHI HEAVY INDUSTRIES, LTD., Tokyo (JP)

(72) Inventors: Kenji TAKAO, Tokyo (JP); Yusuke HAZUI, Tokyo (JP)

(73) Assignee: MITSUBISHI HEAVY INDUSTRIES, LTD., Tokyo (JP)

(21) Appl. No.: 19/151,883

(22) PCT Filed: Aug. 28, 2023
(86) PCT No.: PCT/JP2023/031009

§ 371 Date: Jul. 29, 2025

(30) Foreign Application Priority Data
Mar. 7, 2023 (JP) 2023-034867

(51) Int. Cl. G05D 1/644; B66F 9/06; G05D 1/667; G05D 1/698; G05D 105/28; G05D 107/70; G05D 109/10

(52) U.S. Cl. CPC G05D 1/644; B66F 9/063; G05D 1/667; G05D 1/698; G05D 2105/28; G05D 2107/70; G05D 2109/10

(57) ABSTRACT

This movement control system comprises: a plurality of first mobile bodies that automatically move within a first region and transport, into a relay region, a plurality of objects arranged in the first region; at least one second mobile body that automatically moves within a second region different from the first region and transports, out to the second region, the objects transported into the relay region; and a control unit that makes, when one operation of either transporting the objects into or transporting the objects out from the relay region has not been completed and consequently it has become impossible to execute the other operation, a choice between executing a standby operation to stand by until said one operation is completed and executing a prescribed operation different from the standby operation, and that, on the basis of the result of choice that has been made, controls the first mobile bodies or the second mobile body that cannot execute the other operation.

### TECHNICAL FIELD

The present disclosure relates to a movement control system, a movement control method, and a movement control program.

### BACKGROUND ART

Moving bodies that move automatically to transport objects such as cargo are known. For example, PTL 1 describes a transport system in which an unmanned transport vehicle transports cargo between a plurality of conveyors.

### CITATION LIST

### Patent Literature

[PTL 1] Japanese U.S. Pat. No. 5,729,606

### SUMMARY OF INVENTION

### Technical Problem

In a movement control system for controlling such a moving body, efficient transport of a plurality of objects is required.

The present disclosure has been made in consideration of the above circumstance, and an object of the present disclosure is to provide a movement control system, a movement control method, and a movement control program capable of efficiently transporting a plurality of objects.

### Solution to Problem

According to the present disclosure, there is provided a movement control system including: one or more first moving bodies that automatically move through a first region and that carry a plurality of objects to be disposed in the first region into a relay region; one or more second moving bodies that automatically move through a second region different from the first region and that carry the objects carried into the relay region out of the relay region; and a control unit that, when one of operations of carrying in and carrying out the objects in the relay region has not been completed, and thus another operation is not executable, selects whether to perform a waiting operation of waiting until the one operation is completed or to perform a predetermined operation different from the waiting operation, and controls a moving body that is unable to execute the other operation, out of the first moving body and the second moving body, based on a selection result.

According to the present disclosure, there is provided a movement control method including: a step of carrying a plurality of objects to be disposed in a first region into a relay region by one or more first moving bodies that automatically move through the first region; a step of carrying the objects carried into the relay region out of the relay region by one or more second moving bodies that automatically move through a second region different from the first region; and a step of selecting, when one of operations of carrying in and carrying out the objects in the relay region has not been completed, and thus another operation is not executable, whether to perform a waiting operation of waiting until the one operation is completed or to perform a predetermined operation different from the waiting operation, and controlling a moving body that is unable to execute the other operation, out of the first moving body and the second moving body, based on a selection result.

According to the present disclosure, there is provided a movement control program causing a computer to execute: a step of carrying a plurality of objects to be disposed in a first region into a relay region by one or more first moving bodies that automatically move through the first region; a step of carrying the objects carried into the relay region out of the relay region by one or more second moving bodies that automatically move through a second region different from the first region; and a step of selecting, when one of operations of carrying in and carrying out the objects in the relay region has not been completed, and thus another operation is not executable, whether to perform a waiting operation of waiting until the one operation is completed or to perform a predetermined operation different from the waiting operation, and controlling a moving body that is unable to execute the other operation, out of the first moving body and the second moving body, based on a selection result.

### Advantageous Effects of Invention

According to the present disclosure, a plurality of objects can be transported efficiently.

### BRIEF DESCRIPTION OF DRAWINGS

FIG. 1 is a schematic diagram of a movement control system according to the present embodiment.

FIG. 2 is a schematic diagram of a configuration of a moving body.

FIG. 3 is a schematic block diagram of a management device.

FIG. 4 is a schematic block diagram of an information processing device.

FIG. 5 is a schematic block diagram of a control device of the moving body.

FIG. 6 is a diagram showing an example of transfer instruction information.

FIG. 7 is a diagram showing an example of first designation information.

FIG. 8 is a diagram showing an example of second designation information.

FIG. 9 is a diagram showing an example of schedule information.

FIG. 10 is a diagram showing an example of a case in which designation information is updated.

FIG. 11 is a diagram schematically showing an example of a transport status of an object.

FIG. 12 is a diagram schematically showing an example of a transport status of an object.

FIG. 13 is a diagram schematically showing an example of a waiting operation.

FIG. 14 is a diagram schematically showing an example of a waiting operation.

FIG. 15 is a diagram showing an example of a case in which the schedule information is changed.

FIG. 16 is a diagram schematically showing an example of a predetermined operation.

FIG. 17 is a diagram schematically showing an example of a predetermined operation.

FIG. 18 is a diagram showing an example of a case in which the schedule information is changed.

FIG. 19 is a flowchart showing an example of an operation of the movement control system according to the present embodiment.

FIG. 20 is a diagram showing another example of a work region.

### DESCRIPTION OF EMBODIMENTS

Preferred embodiments of the present disclosure will be described in detail below with reference to the accompanying drawings. Note that the present disclosure is not limited to the embodiments, and when there are a plurality of embodiments, the present disclosure also includes configurations in which the respective embodiments are combined.

### (Movement Control System)

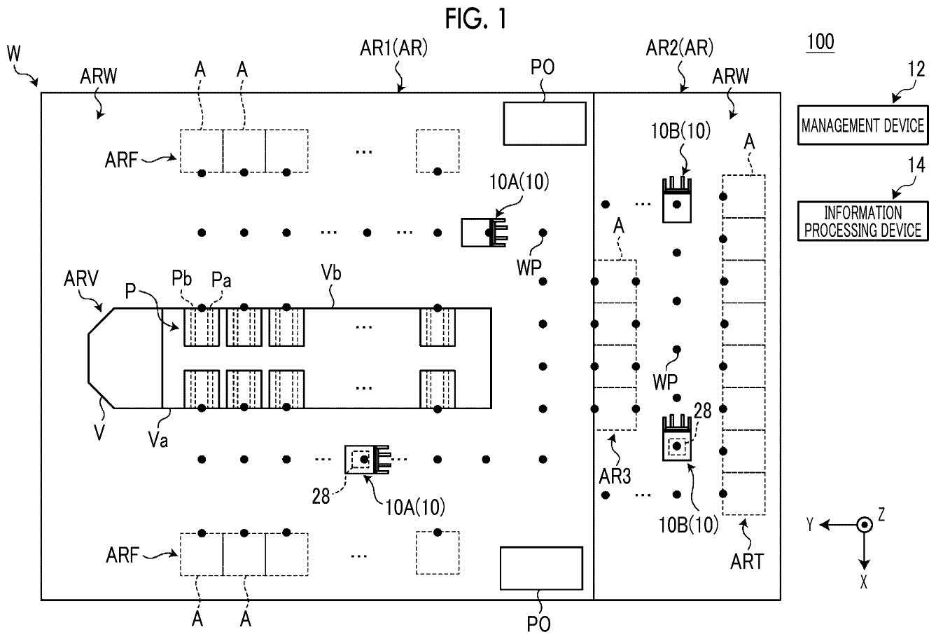

FIG. 1 is a schematic diagram of a movement control system according to the present embodiment. As shown in FIG. 1, a movement control system 100 according to the present embodiment includes a moving body 10, a management device 12, and an information processing device 14. The movement control system 100 is a system that controls a movement of the moving body 10 belonging to a facility W. The facility W is, for example, a facility that is subject to logistics management, such as a warehouse, but may be any facility that operates the moving body 10. In the movement control system 100, the moving body 10 picks up an object P disposed within the facility W, transports the object P, and drops the object P at another place. In the present embodiment, the object P transported by the moving body 10 is a transport target object with cargo loaded on a pallet. Note that the object P is not limited to a transport target object with cargo loaded on the pallet, and may be in any form. For example, the object may be only the cargo without the pallet. In addition, the moving body 10 is not limited to a moving body that transports the object P, and may be a device that moves in the facility W for any purpose.

### (Work Region)

As shown in FIG. 1, a work region AR is set in the facility W. The work region AR is a region where the moving body 10 of the present embodiment performs predetermined work such as loading and unloading work. The work region AR includes a loading/unloading region (first region) AR1 and a transfer region (second region) AR2.

The loading/unloading region AR1 is a region where the moving body 10 is deployed. The moving body 10 is capable of moving within the loading/unloading region AR1. However, the moving body 10 may not be able to move throughout the entire loading/unloading region AR1, and may be unable to move, for example, in a parking region ARV to be described later or in regions where the object P and a fixed object P0 (such as pillars or walls within the facility W) are located. In the following description, one direction along the loading/unloading region AR1 is defined as an X direction, and a direction along the loading/unloading region AR1 that intersects with the direction X is defined as a Y direction. In the present embodiment, the Y direction is a direction orthogonal to the X direction. The X direction and the Y direction may be referred to as directions along a horizontal plane. In the X direction and the Y direction, a direction of an arrow is indicated as a +direction (or +side), and a direction opposite to the +direction is indicated as a−direction (or −side). In addition, a direction orthogonal to the X direction and the Y direction, more specifically, a direction toward an upper side in a vertical direction, is referred to as a Z direction. In addition, in the present embodiment, unless otherwise specified, “position” refers to a position (coordinates) in a coordinate system on a two-dimensional surface on the loading/unloading region AR1 (the coordinate system of the loading/unloading region AR1). In addition, the term “posture (orientation)” of the moving body 10 or the like refers to an orientation of the moving body 10 or the like in the coordinate system of the loading/unloading region AR1, and indicates a yaw angle (rotation angle) of the moving body 10 when the X direction is set to 0° in a case in which the moving body 10 or the like is viewed in the Z direction, unless otherwise specified.

The loading/unloading region AR1 is a so-called truck berth, and includes a parking region ARV where a transport vehicle V is parked, and a movement region ARW in which the moving body 10 can move. The parking region ARV is a region for parking the transport vehicle V, and the movement region ARW is a region of the loading/unloading region AR1 other than the parking region ARV. It is preferable that the transport vehicle V is parked in a predetermined position and posture relative to the parking region ARV. The transport vehicle V is a moving body that transports the loaded object P between the inside and outside of the facility W. For example, the transport vehicle V arrives at the facility W with an object P loaded thereon and is stopped in the parking region ARV, and the loaded object P is then carried out by the moving body 10. In addition, an object P may be loaded by the moving body 10 onto the transport vehicle V stopped in the parking region ARV. In the present embodiment, the transport vehicle V is a truck, but is not limited thereto and may be any moving body that transports the object P, such as a rail vehicle. The transport vehicle V is provided with an accommodation chamber Va in which the object P is disposed. In the example of FIG. 1, doors Vb are provided on both sides (the +X side and the −X side) of the transport vehicle V. With the door Vb open, the moving body 10 approaches the accommodation chamber Va from an opening portion (here, the side) of the door Vb of the transport vehicle V, thereby picking up an object P in the accommodation chamber Va or dropping the object P into the accommodation chamber Va. However, the transport vehicle V is not limited to one having the door Vb provided on the side, and the door Vb may be provided at any position of the transport vehicle V (for example, at the rear).

It is preferable that a temporary installation region ARF in which the object P is disposed is also set in the loading/unloading region AR1. The temporary installation region ARF is set in a partial region within the movement region ARW. In the example of the present embodiment, since the temporary installation region ARF is at the same height as the movement region ARW, the moving body 10 can enter the temporary installation region ARF where the object P is not disposed. However, the present disclosure is not limited to the above, and the moving body 10 may not be able to enter the temporary installation region ARF. In the example of FIG. 1, the loading/unloading region AR1 is set on the X direction side and the opposite side to the X direction of the parking region ARV within the loading/unloading region AR1. However, the position and the number of the temporary installation regions ARF are arbitrary, and they may be provided at any position separate from the parking region ARV. In the present embodiment, the temporary installation region ARF is a temporary placement area for the object P. That is, for example, depending on the operation status of the facility W, an object P loaded on the transport vehicle V or an object P scheduled to be loaded on the transport vehicle V may be temporarily placed in the temporary installation region ARF. The object P temporarily placed in the temporary installation region ARF is transported to another place (for example, the transport vehicle V or a transfer region AR2 to be described later). However, the purpose of the transfer region AR2 is not limited to a temporary placement area. The transfer region AR2 may be a region for any purpose in which the object P is installed.

The temporary installation region ARF includes a plurality of unit regions A. The unit region A is a region set for disposing the object P, and can be said to be a region where the object P is likely to be installed. The shape and the size of the unit region A are set in advance. In the example of FIG. 1, the unit region A is rectangular, but the shape and the size thereof may be arbitrary. Moreover, the unit region A is partitioned for each object P, and one object P is disposed in each unit region A. In each unit region A, depending on the status of the facility W, there is a case in which the object P is disposed and a case in which the object P is not disposed. In the example of FIG. 1, the unit regions A are set to be aligned in the Y direction in the temporary installation region ARF, but the alignment and the number of the unit regions A in the temporary installation region ARF may be arbitrary.

Although there is one loading/unloading region AR1 in the example of FIG. 1, there may be a plurality of loading/unloading regions AR1. That is, for example, a plurality of loading/unloading regions AR1 including the parking region ARV and the movement region ARW may be set to be aligned in the X direction. In addition, the loading/unloading region AR1 is not limited to a truck berth including the parking region ARV and the movement region ARW, and may be any region where the moving body 10 moves (performs work).

The transfer region AR2 is provided at a position adjacent to the loading/unloading region AR1 (the movement region ARW). In the example of FIG. 1, the transfer region AR2 is located on the −Y side of the loading/unloading region AR1 (movement region ARW). The transfer region AR2 includes a disposition region ART. The disposition region ART is for disposing the object P. The disposition region ART includes a plurality of unit regions A. The disposition, the shape, and the like of the unit region A are not limited to the example shown in FIG. 1.

In the present embodiment, the moving body 10 in the loading/unloading region AR1 can drop the object P in the transfer region AR2 and pick up the object P disposed in the transfer region AR2, but it is preferable that the moving body 10 does not move in the transfer region AR2. For example, the transfer region AR2 is located on the Z direction side with respect to the loading/unloading region AR1 (that is, is set at a position higher than the loading/unloading region AR1). The moving body 10 is restricted from entering between the loading/unloading region AR1 and the transfer region AR2. In other words, the moving body 10 is restricted from entering the transfer region AR2 from the loading/unloading region AR1. In addition, the moving body 10 is restricted from entering the loading/unloading region AR1 from the transfer region AR2. In addition, the moving body 10 in the loading/unloading region AR1 may be able to enter the transfer region AR2, and the moving body 10 in the transfer region AR2 may be able to enter the loading/unloading region AR1. For example, the loading/unloading region AR1 and the transfer region AR2 may be set at the same height. Hereinafter, when the moving body 10 moving in the loading/unloading region AR1 and the moving body 10 moving in the transfer region AR2 are distinguished from each other, the moving body 10 moving in the loading/unloading region AR1 will be referred to as a first moving body 10A, and the moving body 10 moving in the transfer region AR2 will be referred to as a second moving body 10B.

A relay region AR3 is provided in a part of the transfer region AR2. The relay region AR3 is a region for disposing the object P. In the present embodiment, the relay region AR3 delivers the object P between the loading/unloading region AR1 and the transfer region AR2. The relay region AR3 can be accessed by the moving body 10 from both the loading/unloading region AR1 and the transfer region AR2. The relay region AR3 may be provided between the loading/unloading region AR1 and the transfer region AR2, or may be provided in a part of the loading/unloading region AR1. For example, the moving body 10 in the loading/unloading region AR1 carries the object P picked up from the transport vehicle V or the temporary installation region ARF into the relay region AR3. In addition, the moving body 10 in the loading/unloading region AR1 picks up the object P carried into the relay region AR3, carries the object P out of the relay region AR3, and transports the object P to the transport vehicle V or the temporary installation region ARF. In addition, the moving body 10 in the transfer region AR2 picks up the object P carried into the relay region AR3, carries the object P out of the relay region AR3, and transports the object P to the disposition region ART. In addition, the moving body 10 in the transfer region AR2 carries the object P disposed in the disposition region ART into the relay region AR3. The relay region AR3 is not limited to the delivery of the object P, and may be used for other purposes.

The relay region AR3 includes a plurality of unit regions A. In the example of FIG. 1, the unit regions A are set to be aligned in the X direction in the relay region AR3, but the alignment and the number of the unit regions A in the relay region AR3 may be arbitrary. The relay region AR3 may be provided at a plurality of locations in the work region AR. For example, when a plurality of loading/unloading regions AR1 are provided to be aligned in the X direction, a configuration may be employed in which the relay region AR3 is provided for each of the loading/unloading regions AR1.

### (Waypoint)

In the work region AR, a waypoint WP is set for each position (coordinates). The movement route of the moving body 10 is set to connect the waypoints WP. That is, a route connecting the waypoints WP through which the moving body 10 is scheduled to pass becomes the movement route of the moving body 10. The waypoints WP are set according to the layout of the work region AR. For example, the waypoints WP may be set in a matrix pattern in the region in which the moving body 10 can move within the work region AR. In addition, the waypoint WP is set in advance according to a position where the object P is disposed in the parking region ARV. In addition, the waypoint WP can be set to correspond to a unit region A or the like in which the object P is disposed in the work region AR. For example, the waypoint WP can be set at a position (coordinates) corresponding to each unit region A.

### (Moving Body)

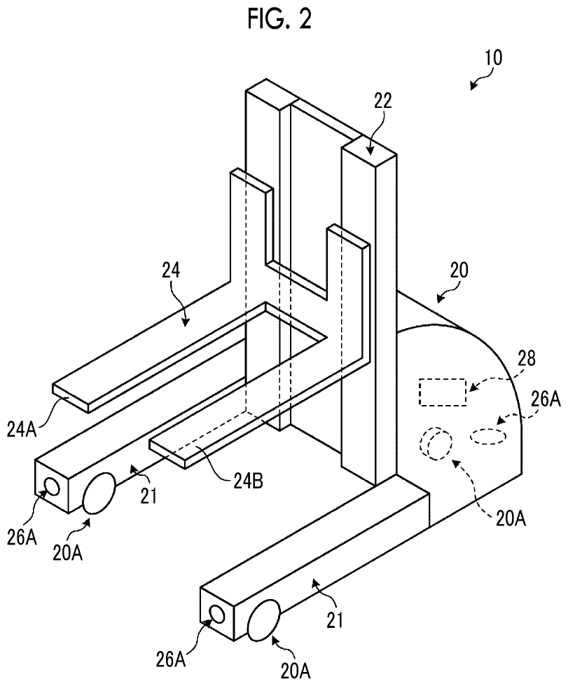

FIG. 2 is a schematic diagram of a configuration of the moving body. The moving body 10 is a device capable of moving automatically. In the present embodiment, the moving body 10 is a non-holonomic system that cannot move directly sideways. The moving body 10 may be configured as a three-wheel drive vehicle with three-wheel steering. Furthermore, the moving body 10 may be configured to be capable of moving directly sideways, or to be capable of pivot turning. In the present embodiment, the moving body 10 is a device capable of transporting a target object. Additionally, in the present embodiment, the moving body 10 is a forklift, and more specifically, is a so-called automated guided vehicle (AGV) or an automated guided forklift (AGF). However, the moving body 10 is not limited to being a forklift that transports a target object, and may be any device that can move automatically.

As shown in FIG. 2, the moving body 10 includes a vehicle body 20, wheels 20A, straddle legs 21, a mast 22, a fork 24, a sensor 26A, and a control device 28. The straddle legs 21 are a pair of shaft-shaped members provided at one end portion of the vehicle body 20 in a front-rear direction and protruding from the vehicle body 20. The wheels 20A are provided at a tip of each of the straddle legs 21 and on the vehicle body 20. That is, although a total of three wheels 20A are provided, positions and the number of the wheels 20A may be arbitrary. The mast 22 is movably attached to the straddle legs 21 and moves in the front-rear direction of the vehicle body 20. The mast 22 extends along an up-down direction (here, a direction Z) orthogonal to the front-rear direction. The fork 24 is attached to the mast 22 to be movable in the direction Z. The fork 24 may also be movable relative to the mast 22 in a lateral direction (a direction intersecting the up-down direction and the front-rear direction) of the vehicle body 20. The fork 24 has a pair of forks 24A and 24B. The forks 24A and 24B extend from the mast 22 toward a front direction of the vehicle body 20. The fork 24A and the fork 24B are spaced apart from each other in the lateral direction of the mast 22. Hereinafter, in the front-rear direction, a direction on the side on which the fork 24 is provided in the moving body 10 is referred to as a front direction, and a direction on the side on which the fork 24 is not provided is referred to as a rear direction.

The sensor 26A detects at least one of a position and a posture of an object present around the vehicle body 20. It can also be said that the sensor 26A detects at least one of the position of the object with respect to the moving body 10 and the posture of the object with respect to the moving body 10. In the present embodiment, the sensor 26A is provided at the tip of each straddle leg 21 in the front direction and on the rear direction side of the vehicle body 20. Note that a position where the sensor 26A is provided is not limited thereto, and the sensor 26A may be provided at any position, and the number of the sensors 26A provided may also be arbitrary.

The sensor 26A is, for example, a sensor that emits laser light. The sensor 26A emits laser light while performing scanning in one direction (here, the lateral direction) and detects the position and the orientation of the object from reflected light of the emitted laser light. That is, the sensor 26A can also be said to be a so-called two-dimensional (2D)-light detection and ranging (LiDAR) sensor. Here, the sensor 26A is not limited to the above and may be a sensor that detects the object using any method, for example, a so-called three-dimensional (3D)-LiDAR that performs scanning in a plurality of directions, a so-called one-dimensional (1D)-LiDAR that does not perform scanning, or a camera.

The control device 28 controls movement of the moving body 10. The control device 28 will be described below.

### (Management Device)

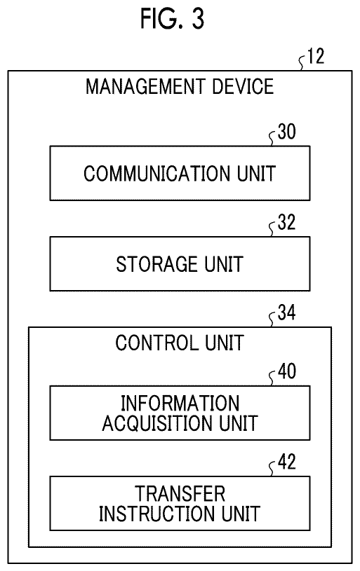

FIG. 3 is a schematic block diagram of the management device. The management device 12 is a system that manages logistics in the facility W. Although the management device 12 is a warehouse control system (WCS) or a warehouse management system (WMS) in the present embodiment, the management device 12 is not limited to the WCS and the WMS and may be any system, for example, a back-end system such as another production management system. A position where the management device 12 is provided is arbitrary, and the management device 12 may be provided in the facility W or may be provided at a position away from the facility W to manage the facility W from that position. The management device 12 is a computer, and as shown in FIG. 3, includes a communication unit 30, a storage unit 32, and a control unit 34.

The communication unit 30 is a module used for the control unit 34 and communicating with an external device such as the information processing device 14, and may include, for example, an antenna or the like. A communication method of the communication unit 30 is wireless communication in the present embodiment, but the communication method may be arbitrary. The storage unit 32 is a memory that stores various kinds of information, such as calculation contents of the control unit 34 and programs, and includes, for example, at least one of a main storage device such as a random-access memory (RAM) or a read-only memory (ROM) and an external storage device such as a hard disk drive (HDD).

The control unit 34 is a calculation device, and includes, for example, a calculation circuit such as a central processing unit (CPU). The control unit 34 includes an information acquisition unit 40 and a transfer instruction unit 42. The control unit 34 reads out and executes a program (software) from the storage unit 32, thereby realizing the information acquisition unit 40 and the transfer instruction unit 42 and executing the processes thereof. The control unit 34 may execute the processes using one CPU or may include a plurality of CPUs and execute the processes using the plurality of CPUs. Furthermore, at least a part of the information acquisition unit 40 and the transfer instruction unit 42 may be realized by a hardware circuit. In addition, the program for the control unit 34 stored in the storage unit 32 may be stored in a recording medium that can be read by the management device 12.

The information acquisition unit 40 acquires information such as a scheduled arrival time of the transport vehicle V moving toward the facility W, the number of objects P loaded on the transport vehicle V, and the availability of the disposition region ART provided in the transfer region AR2 of the facility W. The transfer instruction unit 42 generates transfer instruction information based on the acquired information and causes the communication unit 30 to transmit the generated transfer instruction information. The transfer instruction information is information for instructing the transfer of the plurality of objects P disposed in the loading/unloading region AR1 to the transfer region AR2. The specific contents thereof will be described below.

### (Information Processing Device)

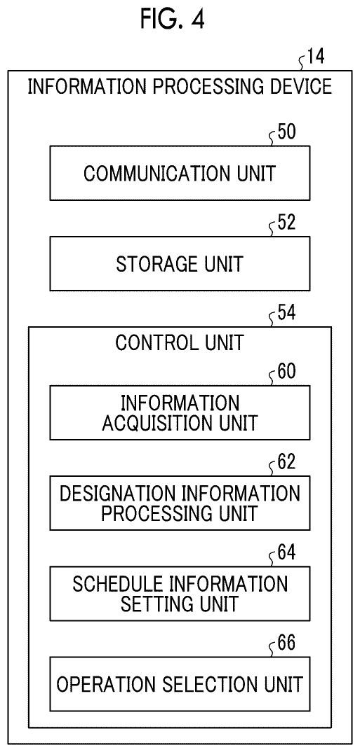

FIG. 4 is a schematic block diagram of the information processing device. The information processing device 14 is a device that processes information related to the movement of the moving body 10. The information processing device 14 is, for example, a fleet control system (FCS), but is not limited thereto, and may be any device that processes the information related to the movement of the moving body 10. The information processing device 14 is a computer, and as shown in FIG. 4, includes a communication unit 50, a storage unit 52, and a control unit 54. The communication unit 50 is a module used for the control unit 54 and communicating with an external device such as the management device 12 and the moving body 10, and may include, for example, an antenna. A communication method of the communication unit 50 is wireless communication in the present embodiment, but the communication method may be arbitrary. The storage unit 52 is a memory that stores various kinds of information, such as calculation contents of the control unit 54 and programs, and includes, for example, at least one of a main storage device such as a RAM or a ROM and an external storage device such as an HDD.

The control unit 54 is a calculation device, and includes, for example, a calculation circuit such as a CPU. The control unit 54 includes an information acquisition unit 60, a designation information processing unit 62, a schedule information setting unit 64, and an operation selection unit 66. The control unit 54 reads out and executes a program (software) from the storage unit 52, thereby realizing the information acquisition unit 60, the designation information processing unit 62, the schedule information setting unit 64, and the operation selection unit 66 and executing the processes thereof. The control unit 54 may execute the processes using one CPU or may include a plurality of CPUs and execute the processes using the plurality of CPUs. Furthermore, at least a part of the information acquisition unit 60, the designation information processing unit 62, the schedule information setting unit 64, and the operation selection unit 66 may be realized by a hardware circuit. In addition, the program for the control unit 54 stored in the storage unit 52 may be stored in a recording medium that can be read by the information processing device 14.

The information acquisition unit 60 acquires the transfer instruction information transmitted from the management device 12. The information acquisition unit 60 acquires a transport status of the moving body 10 transmitted from the moving body 10. The designation information processing unit 62 generates and updates designation information based on the acquired information. The designation information includes first designation information for designating a position in the relay region AR3, which is a transport destination, for each of the plurality of objects P disposed in the loading/unloading region AR1, and second designation information for designating a position in the transfer region AR2, which is a transport destination, for each of the objects P disposed in the relay region AR3. The schedule information setting unit 64 sets schedule information of the moving body 10. When a determination unit 86 (to be described later) determines that a situation has occurred in which one of the operations of dropping (carrying in) and picking up (carrying out) of the object P in the relay region AR3 has not been completed, and thus the other operation cannot be executed, the operation selection unit 66 selects whether to perform a waiting operation of waiting until one operation is completed or to perform a predetermined operation different from the waiting operation. Specific processing contents thereof will be described below.

In the present embodiment, the management device 12 and the information processing device 14 are separate devices, but may be integrated into one device. That is, the management device 12 may have at least some functions of the information processing device 14, and the information processing device 14 may have at least some functions of the management device 12.

### (Control Device of Moving Body)

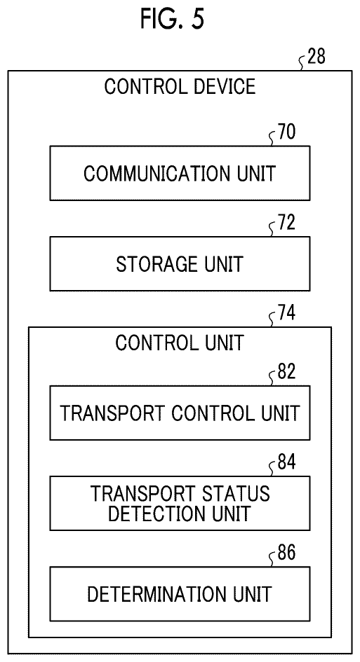

Next, the control device 28 of the moving body 10 will be described. FIG. 5 is a schematic block diagram of the control device of the moving body. The control device 28 is a device that controls the moving body 10. The control device 28 is a computer, and as shown in FIG. 5, includes a communication unit 70, a storage unit 72, and a control unit 74. The communication unit 70 is a module used for the control unit 74 and communicating with an external device such as the information processing device 14, and may include, for example, an antenna. A communication method of the communication unit 70 is wireless communication in the present embodiment, but the communication method may be arbitrary. The storage unit 72 is a memory that stores various kinds of information, such as calculation contents of the control unit 74 and programs, and includes, for example, at least one of a main storage device such as a RAM or a ROM and an external storage device such as an HDD. The storage unit 72 stores, for example, information about the time required for the operation of the moving body 10, such as the time required for the moving body 10 to perform the operation of picking up one object P, the time required for the moving body 10 to perform the operation of dropping one object P, and the time required for the moving body 10 to move between waypoints WP.

The control unit 74 is a calculation device, and includes, for example, a calculation circuit such as a CPU. The control unit 74 includes a transport control unit 82, a transport status detection unit 84, and a determination unit 86. The control unit 74 reads out and executes a program (software) from the storage unit 72, thereby realizing the schedule information setting unit 80, the transport control unit 82, the transport status detection unit 84, and the determination unit 86 and executing the processes thereof. The control unit 74 may execute the processes using one CPU or may include a plurality of CPUs and execute the processes using the plurality of CPUs. Furthermore, at least a part of the transport control unit 82, the transport status detection unit 84, and the determination unit 86 may be realized by a hardware circuit. In addition, the program for the control unit 74 stored in the storage unit 72 may be stored in a recording medium that can be read by the control device 28.

The transport control unit 82 controls a movement mechanism of the moving body 10, such as a drive unit or steering, to control the movement of the moving body 10. The transport status detection unit 84 detects a movement status of the object P by the moving body 10 based on a detection result of the sensor 26A, an operation history of the moving body 10, and the like. The transport status detection unit 84 causes the communication unit 70 to transmit the detected movement status to the information processing device 14. The determination unit 86 determines whether or not a situation has occurred in which one of the operations of dropping (carrying in) and picking up (carrying out) of the object P in the relay region AR3 has not been completed, and thus the other operation cannot be executed. Specific processing contents thereof will be described below.

### (Processing of Movement Control System)

The processing contents of the movement control system 100 will be described below.

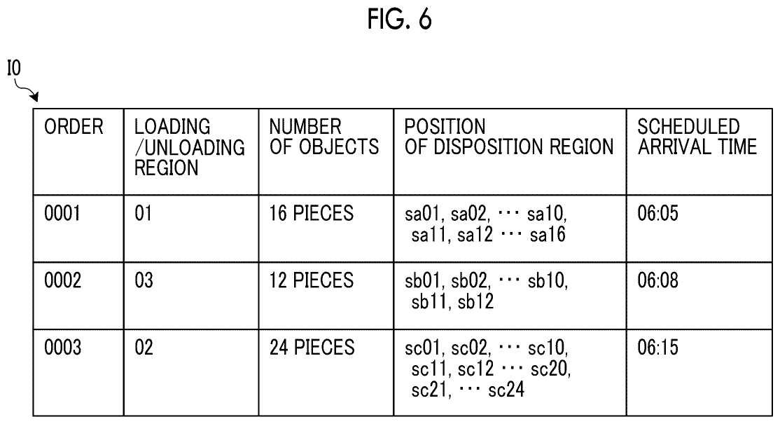

In the management device 12, the information acquisition unit 40 acquires information such as a scheduled arrival time of the transport vehicle V moving toward the facility W, the number of objects P loaded on the transport vehicle V, and the availability of the disposition region ART provided in the transfer region AR2 of the facility W. The transfer instruction unit 42 generates transfer instruction information based on the acquired information. The transfer instruction information is information for instructing the transfer of the plurality of objects P disposed in the loading/unloading region AR1 to the transfer region AR2. FIG. 6 is a diagram showing an example of transfer instruction information I0. As shown in FIG. 6, the transfer instruction information I0 includes, for each transport vehicle V that stops in the loading/unloading region AR1, an order number, a position or identification information of the parking region ARV, a range of the disposition region ART in the transfer region AR2, time information such as the scheduled arrival time of the transport vehicle V, and the like. The transfer instruction unit 42 causes the communication unit 30 to transmit the generated transfer instruction information I0.

In the information processing device 14, the communication unit 50 receives the transfer instruction information I0. The information acquisition unit 60 acquires the received transfer instruction information I0. The designation information processing unit 62 generates designation information for designating the transport destination of the object P, based on the acquired transfer instruction information I0. The designation information includes first designation information for the first moving body 10A moving in the loading/unloading region AR1 and second designation information for the second moving body 10B moving in the transfer region AR2.

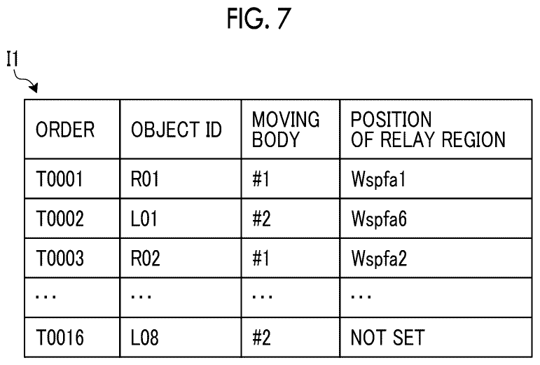

FIG. 7 is a diagram showing an example of first designation information I1. The first designation information I1 is information for designating a position in the relay region AR3, which is a transport destination, for each of the plurality of objects P disposed in the loading/unloading region AR1. As the position in the relay region AR3, which is a transport destination, for example, the position or identification information of each unit region A in the relay region AR3 can be given. Further, the first designation information I1 includes information for designating the moving body 10 that transports the object P for each object P. As shown in FIG. 7, the first designation information I1 includes an order number, identification information of the object P, identification information of the moving body 10 that transports the object P, the position or identification information of the unit region A of the relay region AR3 indicating a transport destination of the object P, and the like.

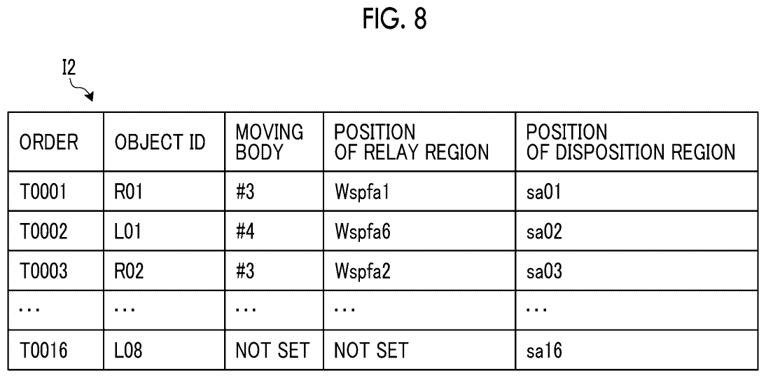

FIG. 8 is a diagram showing an example of second designation information I2. The second designation information I2 is information for designating a position in the transfer region AR2, which is a transport destination, for each of the objects P disposed in the relay region AR3. As the position in the transfer region AR2, which is a transport destination, for example, the position or identification information of each unit region A of the disposition region ART described above can be given. As shown in FIG. 8, the second designation information I2 includes an order number, identification information of the object P, identification information of the moving body 10 that transports the object P, the position or identification information of the unit region A of the relay region AR3 indicating a transport source of the object P, the position or identification information of the unit region A of the disposition region ART indicating a transport destination of the object P, and the like.

Depending on the transport status of the object P by the first moving body 10A and the second moving body 10B, it may be difficult to set which moving body 10 will transport the object P, the transport destination of the object P to be transported by the first moving body 10A and the second moving body 10B, the transport source of the object P to be transported by the second moving body 10B, or the like. In such a case, the designation information processing unit 62 can set an item to be set as “non-set state”, for example, “not set”.

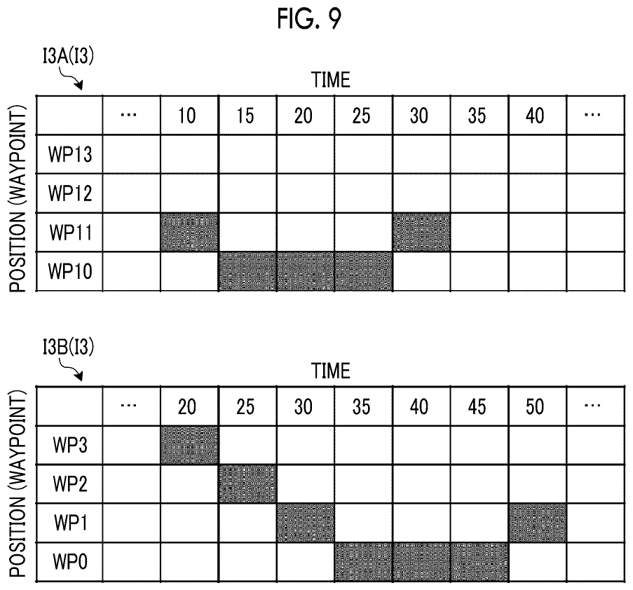

The schedule information setting unit 64 generates schedule information for designating a timing when the object P is transported to the moving body 10. Note that the schedule information may be generated in the control device 28 of the moving body 10. That is, the function corresponding to the schedule information setting unit 64 may be provided in the control unit 74 of the control device 28. FIG. 9 is a diagram showing an example of schedule information I3. As shown in FIG. 9, the schedule information 13 includes first schedule information I3A for the first moving body 10A and second schedule information I3B for the second moving body 10B. In FIG. 9, a horizontal axis represents time.

As shown in FIG. 9, the first schedule information I3A defines a schedule for a series of transport operations of the first moving body 10A, in which the first moving body 10A moves to the transport vehicle V, picks up the object P with the transport vehicle V, moves to the relay region AR3, drops the object P in the unit region A of the relay region AR3, and moves again toward the transport vehicle V. In the first schedule information I3A shown in FIG. 9, a part of the transport operation of the first moving body 10A is shown.

In addition, as shown in FIG. 9, the second schedule information I3B defines a schedule for a series of transport operations of the second moving body 10B, in which the second moving body 10B moves to the relay region AR3, picks up the object P in the unit region A of the relay region AR3, moves to the disposition region ART, and drops the object P in the unit region A of the disposition region ART. In the second schedule information I3B shown in FIG. 9, a part of the transport operation of the second moving body 10B is shown.

In FIG. 9, in the first schedule information I3A and the second schedule information I3B, for each waypoint WP that the first moving body 10A and the second moving body 10B are scheduled to pass through or stop at, a timing when the first moving body 10A and the second moving body 10B pass through the waypoint WP or a timing when the first moving body 10A and the second moving body 10B stop at the waypoint WP is defined.

The control device 28 of the moving body 10 controls the operations of the moving body 10 based on the first designation information I1, the second designation information I2, and the schedule information I3 generated by the schedule information setting unit 64. That is, the control device 28 of the first moving body 10A controls the operations of the first moving body 10A based on the first designation information I1 and the schedule information I3. In addition, the control device 28 of the second moving body 10B controls the operations of the second moving body 10B based on the second designation information I2 and the schedule information I3.

The transport control unit 82 controls the moving body 10 based on the schedule information. The first moving body 10A and the second moving body 10B move in the work region AR, and transport the object P based on the control of the transport control unit 82. The transport status detection unit 84 detects the transport status of each moving body 10, and transmits the detection result to the information processing device 14.

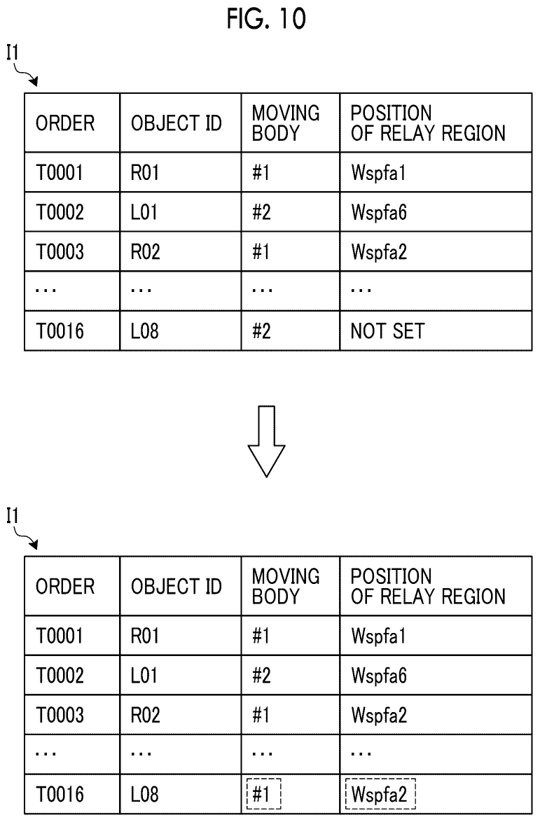

In the information processing device 14, the communication unit 50 receives the transmitted transport status. The information acquisition unit 60 acquires the received transport status. The designation information processing unit 62 detects the transport status of the object P based on the transport status of each moving body 10. The designation information processing unit 62 can update the first designation information I1, the second designation information I2, and the schedule information I3 according to the transport status of the object P. FIG. 10 is a diagram showing an example of a case in which the designation information is updated. As shown in FIG. 10, the designation information processing unit 62 can appropriately set the setting target items that are not set in the first designation information I1 and the second designation information I2 when the setting target items become settable according to the transport status. In addition, as shown in FIG. 10, the designation information processing unit 62 can also change the settings of the target items set in the first designation information I1 and the second designation information I2 according to the transport status. Accordingly, flexible control can be performed according to the transport status.

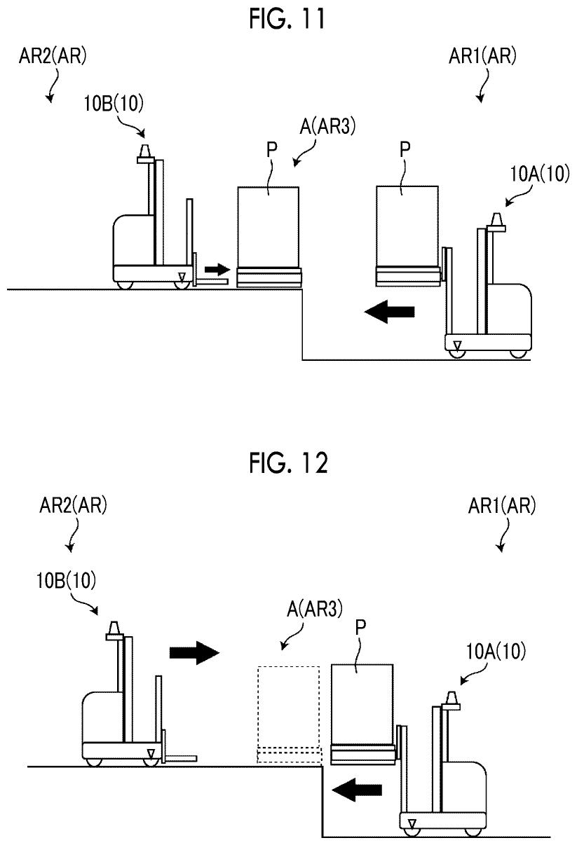

Depending on the transport status of the object P, the transport operation may not proceed according to the schedule information I3 set by the schedule information setting unit 64. FIGS. 11 and 12 are diagrams schematically showing an example of a transport status of the object P. For example, as shown in FIG. 11, in a case in which the object P is scheduled to be dropped (carried in) into the unit region A of the relay region AR3 by the first moving body 10A, when the object P remains in the unit region A where it is scheduled to be dropped or when the second moving body 10B is in the middle of picking up the object P in the unit region A and the pickup has not been completed, the first moving body 10A will be in a state in which it will not be able to drop the object P as scheduled. In addition, for example, as shown in FIG. 12, in a case in which the object P is scheduled to be picked up (carried out) from the unit region A of the relay region AR3 by the second moving body 10B, when the object P is not disposed in the unit region A where it is scheduled to be picked up or when the first moving body 10A is in the middle of dropping the object P in the unit region A and the dropping has not been completed, the second moving body 10B will be in a state in which it will pick up the object P as scheduled.

Information that the object P remains in the unit region A where the moving body 10 is scheduled to drop the object P or that the moving body 10 is in the middle of picking up the object P can be detected, for example, by the operation history of the moving body 10, the sensor 26A of the moving body 10, or the like. Similarly, information that the object P is not present in the unit region A where the moving body 10 is scheduled to pick up the object P or that the moving body 10 is in the middle of dropping the object P can be detected, for example, by the operation history of the moving body 10, the sensor 26A of the moving body 10, or the like. In this way, the moving body 10 can detect a status in which one of the operations of carrying in and carrying out the object P in the relay region AR3 has not been completed, and thus the other operation cannot be executed.

The determination unit 86 of the control device 28 determines, based on the information detected by the moving body 10, whether or not a situation has occurred in which one of the operations of dropping and picking up of the object P in the relay region AR3 has not been completed, and thus the other operation cannot be executed. When the determination unit 86 determines that the situation has not occurred, the transport control unit 82 continues the transport operation.

On the other hand, when the determination unit 86 determines that the situation has occurred, the determination unit 86 transmits the determination result to the information processing device 14. In the information processing device 14, the operation selection unit 66 of the control unit 54 selects whether to perform a waiting operation of waiting until one operation is completed or to perform a predetermined operation different from the waiting operation. The operation selection unit 66 transmits the selection result to the moving body 10. The above-mentioned selection operation of the operation selection unit 66 may be performed by the control unit 74 of the control device 28. That is, a function corresponding to the operation selection unit 66 may be provided in the control unit 74. The operation selection unit 66 calculates, for example, a waiting time required to perform the waiting operation and an operation time required to perform a predetermined operation.

When calculating the waiting time, the operation selection unit 66 can calculate the time required for the remaining operation as the waiting time, for example, based on the total required time for one operation and the transport status of the one operation at the current time. Regarding the transport status of one operation, for example, information acquired by the information acquisition unit 60 can be used.

In addition, when one of the incomplete operations is picking up an object P and the other operation that cannot be executed is dropping the object P, the predetermined operation can be a first operation of first dropping the object P in a temporary placement region (such as a temporary installation region ARF) located in the region of the loading/unloading region AR1 and the transfer region AR2 where the moving body 10 is present, and then picking up the object P dropped in the temporary placement region again and returning the object P to the unit region A of the relay region AR3 where it was originally scheduled to be dropped, or dropping the object P after returning. When calculating the operation time of the first operation, the transport control unit 82 can calculate the operation time as the sum of the times required for each of, for example, the operation of moving from the relay region AR3 to the temporary placement region, the operation of dropping the object P into the unit region A of the temporary placement region, the operation of picking up the dropped object P, and the operation of returning the object P to the relay region AR3.

The operation selection unit 66 causes a different operation to be performed depending on the content of one operation and the other operation, with respect to the predetermined operation. That is, when one of the incomplete operations is dropping an object P and the other operation that cannot be executed is picking up the object P, the predetermined operation can be a second operation of picking up another object P for which the drop to the relay region AR3 has been completed and dropping the other object P into the unit region A as the transport destination, and returning the object P to the unit region of the relay region AR3 where it was originally scheduled to be picked up after being dropped, or picking up the object P after returning. When calculating the operation time of the second operation, the operation selection unit 66 can calculate the operation time as the sum of the times required for each of, for example, the operation of moving to another object P, the operation of picking up the other object P, the operation of holding the other object P and moving to the unit region A, the operation of dropping the other object P in the unit region A, and the operation of moving from the unit region A to the relay region AR3.

When the operation selection unit 66 causes the first operation to be performed, for example, the operation selection unit 66 compares the calculated waiting time with the operation time, and controls the moving body 10 to perform the operation that takes the shorter time. Furthermore, when the operation selection unit 66 causes the second operation to be performed, for example, the operation selection unit 66 causes the second operation to be performed first, putting off the original picking up of the object P, that is, rearranging the work order. Therefore, the operation selection unit 66 calculates the work time required to perform the work that becomes necessary by rearranging the work order, based on the above-mentioned operation times. For example, when a movement distance becomes longer than originally planned by rearranging the work order, the time required to move the longer distance is calculated as the work time. The operation selection unit 66 compares the calculated work time with the above-mentioned waiting time, and controls the moving body 10 to perform the operation that takes the shorter time.

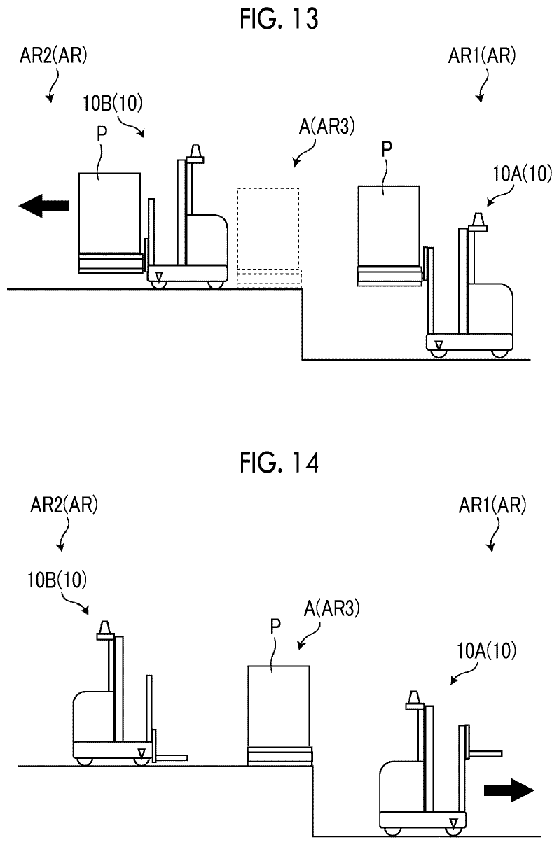

FIGS. 13 and 14 are diagrams schematically showing an example of the waiting operation. As shown in FIGS. 13 and 14, the transport control unit 82 controls the moving body 10 to wait at the position (waypoint WP) of the unit region A in the relay region AR3 where the other operation is scheduled to be performed until one operation is completed. The transport control unit 82 controls the moving body 10 such that after one operation is completed, the other operation is performed.

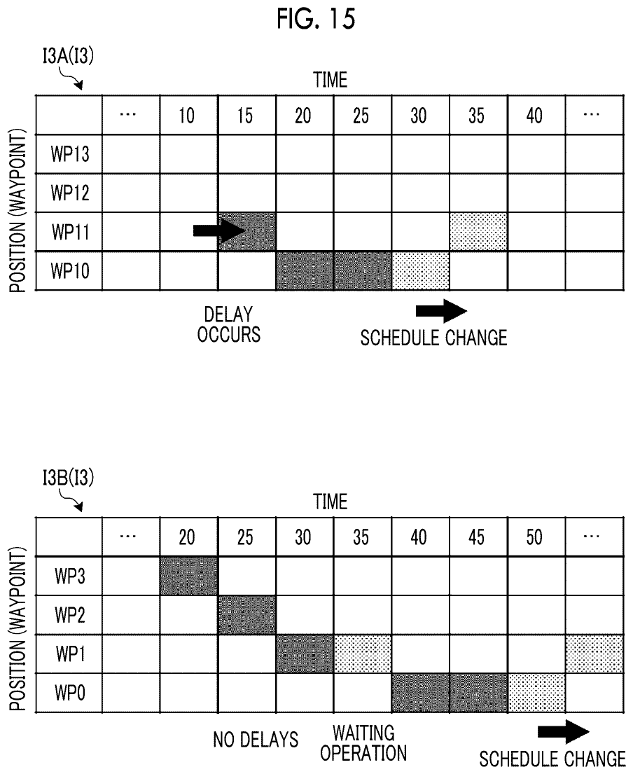

FIG. 15 is a diagram showing an example of a case in which the schedule information is changed. FIG. 15 shows a case in which a delay occurs when the first moving body 10A drops an object P into a unit region A of the relay region AR3, and the delay prevents the second moving body 10B from picking up the object P in the unit region A. In this situation, when the operation selection unit 66 selects the second moving body 10B to perform a waiting operation, the timing information generation unit 64 updates the schedule information I3A of the first moving body 10A to shift the drop schedule forward by the amount of time corresponding to the delay that has occurred. In addition, the timing information generation unit 64 updates the schedule information I3B of the second moving body 10B such that the second moving body 10B performs a waiting operation at the waypoint WP1 before reaching the unit region A, for example. In this case, the timing information generation unit 64 updates the schedule information I3B of the second moving body 10B to shift the pickup work time forward by the amount corresponding to the waiting time required for the waiting operation.

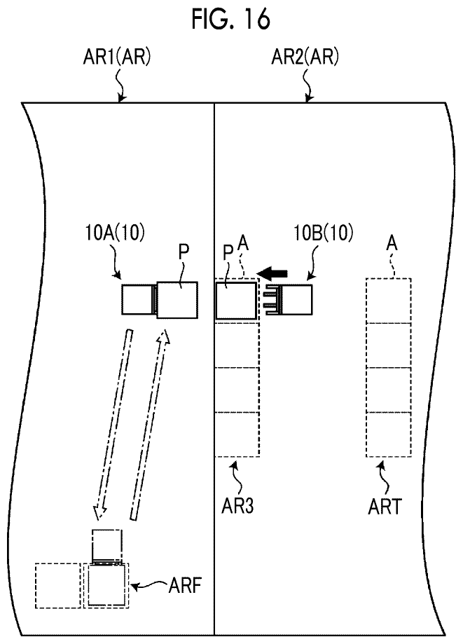

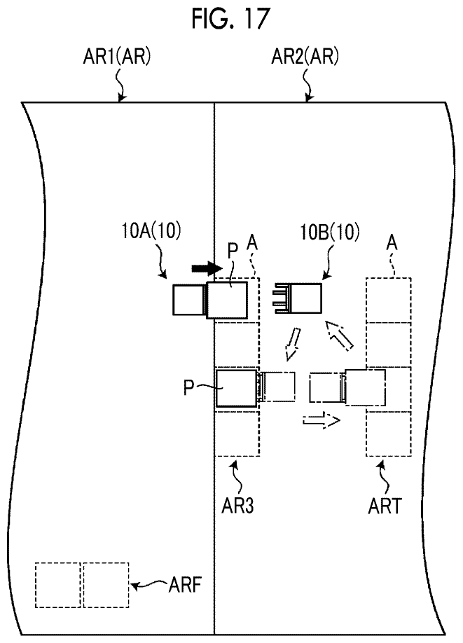

FIGS. 16 and 17 are diagrams schematically showing an example of a predetermined operation. When the first operation is performed as a predetermined operation, as shown in FIG. 16, the transport control unit 82 causes the moving body 10 to perform, for example, the operation of moving from the relay region AR3 to the temporary placement region, the operation of dropping the object P into the unit region A of the temporary placement region, the operation of picking up the dropped object P, and the operation of returning the object P to the relay region AR3.

When the second operation is performed as a predetermined operation, as shown in FIG. 17, the transport control unit 82 causes the moving body 10 to perform, for example, the operation of moving to another object P, the operation of picking up the other object P, the operation of holding the other object P and moving to the unit region A, the operation of dropping the other object P in the unit region A, and the operation of moving from the unit region A to the relay region AR3.

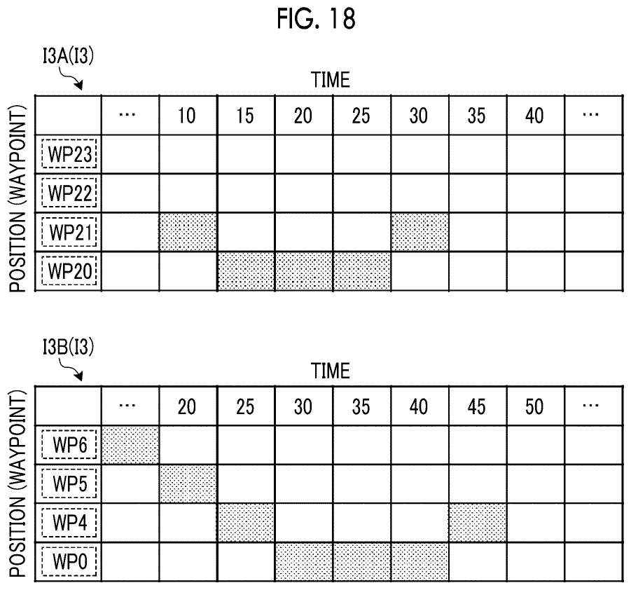

FIG. 18 is a diagram showing an example of a case in which the schedule information is changed. In the case of controlling the moving body 10 to perform a predetermined operation, when the transport status of the object P changes due to the predetermined operation, as shown in FIG. 18, the timing information generation unit 64 adjusts the timing of subsequent operations for the moving body 10 performing the predetermined operation and each moving body 10 other than the moving body 10 performing the predetermined operation, according to the transport status of the object P. For example, the timing information generation unit 64 changes the unit region A that is a target for picking up or dropping the object P, and changes the timing of each operation of moving, picking up, and dropping.

In this way, when one of the operations of carrying in and carrying out the object P in the relay region AR3 has not been completed, and thus the other operation cannot be executed, a selection is made as to whether to perform a waiting operation of waiting until one operation is completed or to perform a predetermined operation different from the waiting operation, and based on the selection result, the moving body 10 that is unable to execute the other operation, out of the first moving body 10A and the second moving body 10B, is controlled.

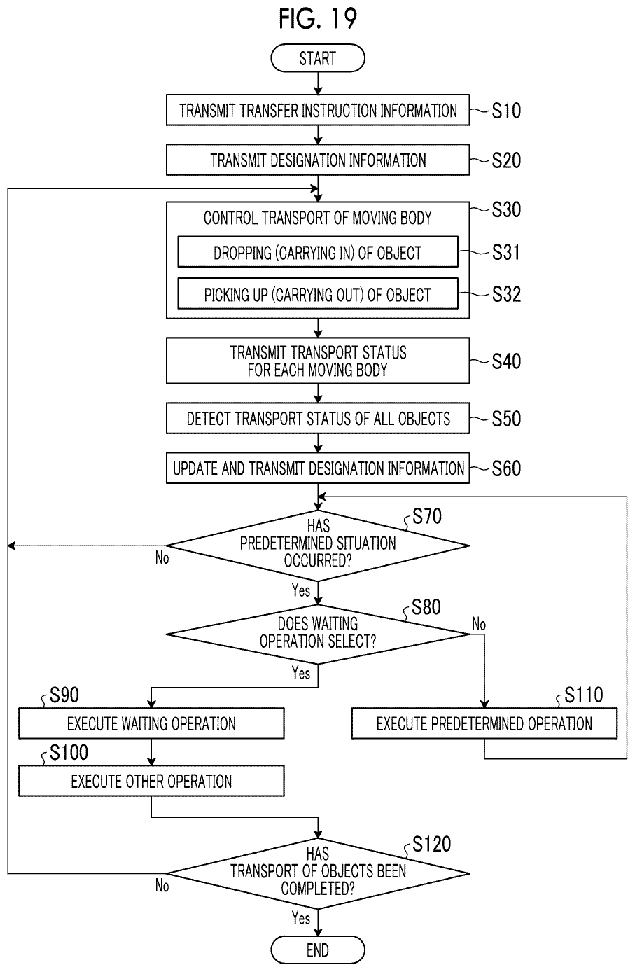

FIG. 19 is a flowchart showing an example of an operation of the movement control system 100 according to the present embodiment. As shown in FIG. 19, in the movement control system 100, the transfer instruction unit 42 of the management device 12 transmits transfer instruction information IO for instructing the transfer of a plurality of objects P disposed in the loading/unloading region AR1 to a transfer region AR2 different from the loading/unloading region AR1 (step S10).

Next, based on the transfer instruction information I0, the designation information processing unit 62 of the information processing device 14 generates and transmits first designation information I1 for designating a position in the relay region AR3, which is a transport destination, for each of the plurality of objects P disposed in the loading/unloading region AR1, and second designation information I2 for designating a position in the transfer region AR2, which is a transport destination, for each of the objects P disposed in the relay region AR3 (step S20).

Next, the transport control unit 82 of the control device 28 controls the plurality of moving bodies 10 that can automatically move and transport the object P based on the first designation information I1 and the second designation information I2 (step S30). Under the control of step S30, for example, the first moving body 10A that automatically moves through the loading/unloading region AR1 drops the plurality of objects P disposed in the loading/unloading region AR1 into the relay region AR3 (step S31). Furthermore, one or more second moving bodies 10B that automatically move through the transfer region AR2 different from the loading/unloading region AR1 pick up the object P that has been carried into the relay region AR3 from the relay region AR3 (step S32). The transport status detection unit 84 detects the transport status of each moving body 10, and transmits the detected result to the information processing device 14 (step S40).

The designation information processing unit 62 of the information processing device 14 detects the transport status of all the objects P based on the transport status of each moving body 10 (step S50). The designation information processing unit 62 updates the first designation information I1 and the second designation information I2 according to the transport status of the object P, and transmits the updated first designation information I1 and second designation information 12 (step S60).

The above-described steps S10 to S60 are an example of a procedure for controlling the transport operation of the plurality of moving bodies 10, but the present disclosure is not limited to this configuration. As long as the plurality of moving bodies 10 can appropriately perform the operations of steps S31 and S32 described above, the transport operation may be performed according to a procedure other than the procedure of steps S10 to S60.

When performing the above-mentioned transport operation, the determination unit 86 of the control device 28 determines whether or not a predetermined situation has occurred in which one of the operations of dropping and picking up of the object P in the relay region AR3 has not been completed, and thus the other operation cannot be executed (step S70). When it is determined that the predetermined situation has not occurred (No in step S70), the process returns to step S30 and the process is performed.

Furthermore, when it is determined in step S70 that a predetermined situation has occurred (Yes in step S70), the operation selection unit 66 selects whether to perform a waiting operation of waiting until one operation is completed or to perform a predetermined operation different from the waiting operation (step S80). When the operation selection unit 66 selects the waiting operation (Yes in step S80), the transport control unit 82 causes the moving body 10 to wait until one operation is completed (step S90). After one operation is completed, the transport control unit 82 causes the moving body 10 to perform the other operation that is scheduled (step S100).

Furthermore, when the operation selection unit 66 selects a predetermined operation rather than a waiting operation (No in step S80), the transport control unit 82 causes the moving body 10 to perform the predetermined operation (step S110), and after the predetermined operation is completed, the process returns to step S70 and the process is performed.

After step S100, the designation information processing unit 62 of the information processing device 14 determines whether or not the transport of all the objects P has been completed based on the transport status of each moving body 10 (step S120). When it is determined that the transport of all the objects P has not been completed (No in step S120), the process returns to step S30 and the process is performed. When it is determined that the transport of all the objects P has been completed (Yes in step S120), the process is completed.

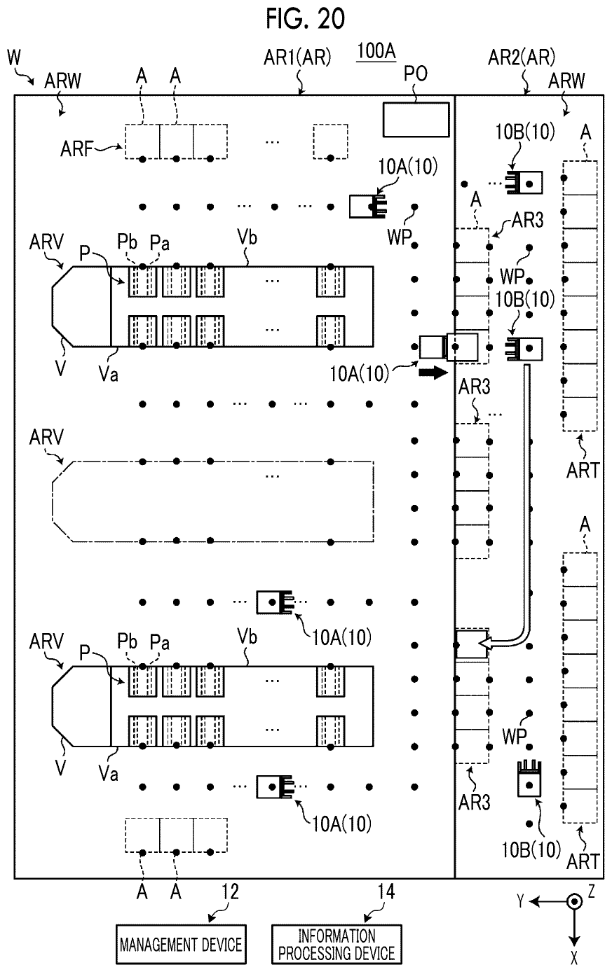

FIG. 20 is a diagram showing another example of the work region AR. As shown in FIG. 20, in the work region AR, a plurality of loading/unloading regions AR1 including the parking region ARV and the movement region ARW are set to be aligned in the X direction. The transfer region AR2 is provided across a plurality of loading/unloading regions AR1. The relay region AR3 is provided for each loading/unloading region AR1. In the example shown in FIG. 20, three loading/unloading regions AR1 are provided to be aligned in the X direction. In this case, loading and unloading work is not set up to be performed simultaneously in all three loading/unloading regions AR1, but rather, for example, loading and unloading work can be set up to be performed simultaneously only in one location in the center in the X direction, or only in two locations on both sides in the X direction.

When loading and unloading work is executed simultaneously at two locations on both sides in the X direction, a plurality of first moving bodies 10A, a plurality of, for example, two first moving bodies 10A exclusive to each loading/unloading region AR1 are disposed in each loading/unloading region AR1. Furthermore, three second moving bodies 10B are disposed in the transfer region AR2. Out of the three second moving bodies 10B, one is disposed exclusively to correspond to the relay region AR3 on the +X side, one is disposed exclusively to correspond to the relay region AR3 on the −X side, and the remaining one is disposed for dual use to correspond to both the relay region AR3 on the +X side and the relay region AR3 on the −X side.

In this case, in the control device 28, when the transport control unit 82 causes the second moving body 10B to perform a second operation in a predetermined operation, the transport control unit 82 can control the object P that has been carried into a relay region AR3 different from the relay region AR3 where one of the operations has not been completed to be targeted for pickup. This operation can improve the transport efficiency of the object P when the loading/unloading regions AR1 on the +X side and the −X side are in operation.

As described above, according to a first aspect of the present disclosure, there is provided a movement control system 100 including: one or more first moving bodies 10A that automatically move through a loading/unloading region AR1 and that carry a plurality of objects P to be disposed in the loading/unloading region AR1 into a relay region AR3; one or more second moving bodies 10B that automatically move through a transfer region AR2 different from the loading/unloading region AR1 and that carry the objects P carried into the relay region AR3 out of the relay region AR3; and a control unit 54 or 74 that, when one of operations of carrying in and carrying out the objects P in the relay region AR3 has not been completed, and thus another operation is not executable, determines whether to perform a waiting operation of waiting until the one operation is completed or to perform a predetermined operation different from the waiting operation, and controls a moving body 10 that is unable to execute the other operation, out of the first moving body 10A and the second moving body 10B, based on a determination result.

According to this configuration, when one of the operations of carrying in and carrying out the object P in the relay region AR3 has not been completed, and thus the other operation cannot be executed, the moving body 10 can be efficiently controlled by selecting and performing a waiting operation or a predetermined operation. Accordingly, a plurality of objects P can be transported efficiently.

According to a second aspect of the present disclosure, in the movement control system according to the first aspect of the present disclosure, the control unit 54 or 74 compares a waiting time required to perform the waiting operation with an operation time required to perform the predetermined operation, and controls the moving body 10 to perform an operation that takes a shorter time. Therefore, the moving body 10 can be efficiently controlled.

According to a third aspect of the present disclosure, in the movement control system according to the first or second aspect of the present disclosure, the one operation is carrying in the object P, the other operation is carrying out the object P, and the predetermined operation is an operation of carrying out another object P for which the carrying into the relay region AR3 has been completed. Therefore, when one operation is carrying in an object P, and the other operation is carrying out an object P, the operation of carrying out the other object P for which the carrying into the relay region AR3 has been completed can be performed as a predetermined operation, and thus the moving body 10 can be efficiently controlled.

According to a fourth aspect of the present disclosure, in the movement control system according to the third aspect of the present disclosure, the relay region AR3 is provided in a plurality of locations, and the other object P to be carried out in the predetermined operation includes an object P carried into a relay region AR3 different from the relay region AR3 where the one operation has not been completed. Therefore, when the relay region AR3 is set in a plurality of locations, objects P disposed in different relay regions AR3 can be transported by a single moving body 10, thereby improving the transport efficiency of the objects P.

According to a fifth aspect of the present disclosure, in the movement control system according to the first or second aspect of the present disclosure, the one operation is carrying out the object P, the other operation is carrying in the object P, and the predetermined operation is an operation of disposing the object P in a temporary installation region ARF provided in the loading/unloading region AR1 and carrying the object P disposed in the temporary installation region ARF into the relay region AR3. Therefore, when the one operation is carrying out the object P, and the other operation is carrying in the object P, an operation of disposing the object P in a temporary installation region ARF provided in the loading/unloading region AR1 and carrying the object P disposed in the temporary installation region ARF into the relay region AR3 can be performed as a predetermined operation, and thus the moving body 10 can be efficiently controlled.

According to a sixth aspect of the present disclosure, in the movement control system according to any one of the first to fifth aspects of the present disclosure, when the control unit 54 or 74 controls the moving body 10 to perform the waiting operation, the control unit 54 or 74 controls a timing of a subsequent operation of the moving body 10 to be delayed by an amount corresponding to a waiting time required to perform the waiting operation. Therefore, the operation of the moving body 10 can be appropriately controlled when the timing of the operation is changed due to the waiting operation.

According to a seventh aspect of the present disclosure, in the movement control system according to any one of the first to fifth aspects of the present disclosure, when the control unit 54 or 74 controls the moving body 10 to perform the predetermined operation, and a transport status of the object P changes due to the predetermined operation, the control unit 54 or 74 adjusts a timing of a subsequent operation of the moving body 10 according to the transport status of the object P. Therefore, the operation of the moving body 10 can be appropriately controlled when the timing of the operation is changed by a predetermined operation.

According to a seventh aspect of the present disclosure, there is provided a movement control method including a step of carrying a plurality of objects P to be disposed in a loading/unloading region AR1 into a relay region AR3 by one or more first moving bodies 10A that automatically move through the loading/unloading region AR1; a step of carrying the objects P carried into the relay region AR3 out of the relay region AR3 by one or more second moving bodies 10B that automatically move through a transfer region AR2 different from the loading/unloading region AR1; and a step of determining, when one of operations of carrying in and carrying out the objects P in the relay region AR3 has not been completed, and thus another operation is not executable, whether to perform a waiting operation of waiting until the one operation is completed or to perform a predetermined operation different from the waiting operation, and controlling a moving body 10 that is unable to execute the other operation, out of the first moving body 10A and the second moving body 10B, based on a determination result. According to this configuration, when one of the operations of carrying in and carrying out the object P in the relay region AR3 has not been completed, and thus the other operation cannot be executed, the moving body 10 can be efficiently controlled by selecting and performing a waiting operation or a predetermined operation. Accordingly, a plurality of objects P can be transported efficiently.

According to an eighth aspect of the present disclosure, there is provided a movement control program causing a computer to execute: a step of carrying a plurality of objects P to be disposed in a loading/unloading region AR1 into a relay region AR3 by one or more first moving bodies 10A that automatically move through the loading/unloading region AR1; a step of carrying the objects P carried into the relay region AR3 out of the relay region AR3 by one or more second moving bodies 10B that automatically move through a transfer region AR2 different from the loading/unloading region AR1; and a step of determining, when one of operations of carrying in and carrying out the objects P in the relay region AR3 has not been completed, and thus another operation is not executable, whether to perform a waiting operation of waiting until the one operation is completed or to perform a predetermined operation different from the waiting operation, and controlling a moving body 10 that is unable to execute the other operation, out of the first moving body 10A and the second moving body 10B, based on a determination result. According to this configuration, when one of the operations of carrying in and carrying out the object P in the relay region AR3 has not been completed, and thus the other operation cannot be executed, the moving body 10 can be efficiently controlled by selecting and performing a waiting operation or a predetermined operation. Accordingly, a plurality of objects P can be transported efficiently.

Although the embodiment of the present disclosure has been described above, the embodiment is not limited by the contents of the embodiment. In addition, the above-described components include those that can be easily assumed by those skilled in the art, those that are substantially the same, and those that are within a so-called equivalent range. Further, the above-described components can be combined as appropriate. Furthermore, various omissions, replacements, or modifications of the above-described components can be made without departing from the concept of the above-described embodiment.

For example, in the above embodiment, a case in which the first region is a loading/unloading region AR1 and the second region is a transfer region AR2, that is, an object P is unloaded from a transport vehicle V stopped in the loading/unloading region AR1 and transferred to the transfer region AR2 of the facility W, has been described as an example, but the present disclosure is not limited to this configuration. For example, a similar description is possible when the first region is a transfer region AR2 and the second region is a loading/unloading region AR1, that is, when an object P disposed in the transfer region AR2 of the facility W is transferred to the loading/unloading region AR1 and loaded onto a transport vehicle V stopped in the loading/unloading region AR1. In this case, the moving body 10 disposed in the transfer region AR2 drops the object P in the relay region AR3, and the moving body 10 disposed in the loading/unloading region AR1 picks up the object P from the relay region AR3.

### REFERENCE SIGNS LIST

10: moving body
10, 10A: first moving body
10, 10B: second moving body
12: management device
14: information processing device
20: vehicle body
20A: wheel
21: straddle leg
22: mast
24: fork
24A, 24B: fork
26A: sensor
28: control device
30, 50, 70: communication unit
32, 52, 72: storage unit
34, 54, 74: control unit
40, 60: information acquisition unit
42: transfer instruction unit
62: designation information processing unit
64: schedule information setting unit
66: operation selection unit
82: transport control unit
84: transport status detection unit
86: determination unit
100, 100A: movement control system
A: unit region
AR: work region
AR1: loading/unloading region
AR2: transfer region
AR3: relay region
ARF: temporary installation region
ART: disposition region
ARV: parking region
ARW: movement region
I0: transfer instruction information
I1: first designation information
I2: second designation information
I3: schedule information
I3A: first schedule information
I3B: second schedule information
P: object
P0: fixed object
V: transport vehicle
Va: accommodation chamber
Vb: door
W: facility
WP: waypoint

1. A movement control system comprising:
one or more first moving bodies that automatically move through a first region and that carry a plurality of objects to be disposed in the first region into a relay region;
one or more second moving bodies that automatically move through a second region different from the first region and that carry the objects carried into the relay region out of the relay region; and
a control unit that, when one of operations of carrying in and carrying out the objects in the relay region has not been completed, and thus another operation is not executable, selects whether to perform a waiting operation of waiting until the one operation is completed or to perform a predetermined operation different from the waiting operation, and controls a moving body that is unable to execute the other operation, out of the first moving body and the second moving body, based on a selection result.
wherein the predetermined operation includes an operation of moving to a position different from a position for the other operation and then moving to the position for the other operation after carrying out of the objects is completed, and
the control unit compares a waiting time required to perform the waiting operation with an operation time required to perform the predetermined operation, and controls the moving body to perform an operation that takes a shorter time.

2. (canceled)

3. The movement control system according to claim 1,
wherein the one operation is carrying in the object,
the other operation is carrying out the object, and
the predetermined operation includes an operation of carrying out another object for which the carrying into the relay region has been completed.

4. The movement control system according to claim 3,
wherein the relay region is provided in a plurality of locations, and
the other object to be carried out in the predetermined operation includes the object carried into the relay region different from the relay region where the one operation has not been completed.

5. The movement control system according to claim 1,
wherein the one operation is carrying out the object,
the other operation is carrying in the object, and
the predetermined operation includes an operation of carrying in the object in into a temporary placement region provided in the first region and carrying out the object carried in the temporary placement region.

6. The movement control system according to claim 1,
wherein, when the control unit controls the moving body to perform the waiting operation, the control unit controls a timing of a subsequent operation of the moving body to be delayed by an amount corresponding to a waiting time required to perform the waiting operation.

7. The movement control system according to claim 1,
wherein, when the control unit controls the moving body to perform the predetermined operation, and a transport status of the object changes due to the predetermined operation, the control unit adjusts a timing of a subsequent operation of the moving body according to the transport status of the object.

8. A movement control method comprising:
a step of carrying a plurality of objects to be disposed in a first region into a relay region by one or more first moving bodies that automatically move through the first region;
a step of carrying the objects carried into the relay region out of the relay region by one or more second moving bodies that automatically move through a second region different from the first region; and
a step of selecting, when one of operations of carrying in and carrying out the objects in the relay region has not been completed, and thus another operation is not executable, whether to perform a waiting operation of waiting until the one operation is completed or to perform a predetermined operation different from the waiting operation, and controlling a moving body that is unable to execute the other operation, out of the first moving body and the second moving body, based on a selection result,
wherein the predetermined operation includes an operation of moving to a position different from a position for the other operation and then moving to the position for the other operation after carrying out of the objects is completed, and
the step of selecting and controlling includes comparing a waiting time required to perform the waiting operation with an operation time required to perform the predetermined operation, and controlling the moving body to perform an operation that takes a shorter time.

9. A computer-readable recording medium having stored thereon a movement control program causing a computer to execute:
a step of carrying a plurality of objects to be disposed in a first region into a relay region by one or more first moving bodies that automatically move through the first region;
a step of carrying the objects carried into the relay region out of the relay region by one or more second moving bodies that automatically move through a second region different from the first region; and
a step of selecting, when one of operations of carrying in and carrying out the objects in the relay region has not been completed, and thus another operation is not executable, whether to perform a waiting operation of waiting until the one operation is completed or to perform a predetermined operation different from the waiting operation, and controlling a moving body that is unable to execute the other operation, out of the first moving body and the second moving body, based on a selection result,
wherein the predetermined operation includes an operation of moving to a position different from a position for the other operation and then moving to the position for the other operation after carrying out of the objects is completed, and
the step of selecting and controlling includes comparing a waiting time required to perform the waiting operation with an operation time required to perform the predetermined operation, and controlling the moving body to perform an operation that takes a shorter time.
